(19) United States
(12) Patent Application Publication
(10) Pub. No.: US 2010/0125599 A1
(43) Pub. Date: May 20, 2010

(54) OBTAINING TRUSTED RECOMMENDATIONS THROUGH DISCOVERY OF COMMON CONTACTS IN CONTACT LISTS

(75) Inventors: TSZ S. CHENG, GRAND PRAIRIE, TX (US); GREGORY P. FITZPATRICK, KELLER, TX (US)

Correspondence Address: PATENTS ON DEMAND, P.A. - IBM CHA, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/272,225

(22) Filed: Nov. 17, 2008

(51) Int. Cl. G06F 17/30; G06F 7/00

(52) U.S. Cl. 707/771; 707/E17.017

(57) ABSTRACT

The present invention discloses a solution for obtaining trusted recommendations through discovery of common contacts in contact lists. The solution can utilize private contact lists (e.g., address book, phone lists) to permit users to search for and obtain trusted recommendations for a product and/or service. The presence of a contact in a contact list is recognized as recommendation of that contact. Recommendations can be determined through searching private contact lists and obtaining implicit relationships based on common contacts of multiple contact lists. Searches can be customized allowing recommendations to reflect results with high probability of confidence. Recommendations can also be affected by the degrees of separation between contact lists, professional peer relationships, expertise of contact list owner, and the like. Recommendation results can provide trusted recommendations for products and/or services without relying on potentially erroneous input.

### BACKGROUND

The present invention relates to the field of social networking and, more particularly, to obtaining trusted recommendations through discovery of common contacts in contact lists.

Historically, utilizing the vast communal experience of the users on the Internet has permitted users to find recommended products and/or services. Harnessing this collective experience is typically achieved through Web sites which allow users to share product/service information. Usually, users rate and/or discuss products/services which they have purchased or used. While useful, these Web sites fall short because they rely on a tenet that a given recommendation should be trustworthy if a sufficiently large number of people agree upon it.

The inherent problem with this assumption is that there is no means to verify the trustworthiness of user(s) who make recommendations. Users must trust one another to be honest and knowledgeable. Unfortunately, users can act out of self-interest and skew ratings/recommendations for specific reasons. It is not uncommon for users to be paid to leave positive or negative ratings/feedback regarding a certain product or service. For instance, paid participants often leave positive reviews (e.g., testimonials) about a service to enhance the likelihood users will purchase or use the service. Further, many Web sites reflect a small portion of users which can distort the true value of the product/service. Additionally, even when intentional skewing or commenter trustworthiness is not an issue, often preferences of a user are very different from those of a majority of users upon which provided recommendations. Thus, the recommendations are ill suited or ill tailored for a given user, even if the recommendations are useful to others.

### BRIEF DESCRIPTION OF THE SEVERAL VIEWS OF THE DRAWINGS

FIG. 1 is a schematic diagram illustrating a system for deriving recommendations from trusted community relationships by analyzing contact lists in accordance with an embodiment of the inventive arrangements disclosed herein.

FIG. 2 is a schematic diagram illustrating a system for obtaining product and/or service recommendations using common contacts discovered in contact lists in accordance with an embodiment of the inventive arrangements disclosed herein.

FIG. 3 is a flowchart illustrating a method for providing trusted recommendations utilizing contact lists in accordance with an embodiment of the inventive arrangements disclosed herein.

### DETAILED DESCRIPTION

The present invention discloses a solution for obtaining trusted recommendations through discovery of common contacts in contact lists. The solution can utilize private contact lists (e.g., address book, phone lists) to permit users to search for and obtain trusted recommendations for a product and/or service. The presence of a contact in a contact list is recognized as recommendation of that contact. That is, a recommendation of a contact is implied by its mere existence in a contact list, which assumes that users generally maintain contacts for which past dealings have occurred and future dealings are contemplated. Recommendations can be determined through searching private (or public) contact lists and obtaining implicit relationships based on common contacts of multiple contact lists. For example, a contact which appears more frequently in contact lists can be recommended over a contact which appears less frequently. Searches can be customized allowing recommendations to reflect results with high probability of confidence. Recommendations can also be affected by the degrees of separation between contact lists, professional peer relationships, expertise of contact list owner, and the like.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer usable or computer readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer usable or computer readable medium may be any medium that can contain, store, communicate, propagate, or transport the program for use by or in connection with the instruction execution system, apparatus, or device. The computer usable medium may include a propagated data signal with the computer usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer or other programmable data processing apparatus to function in a particular manner, such that the instructions stored in the computer readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

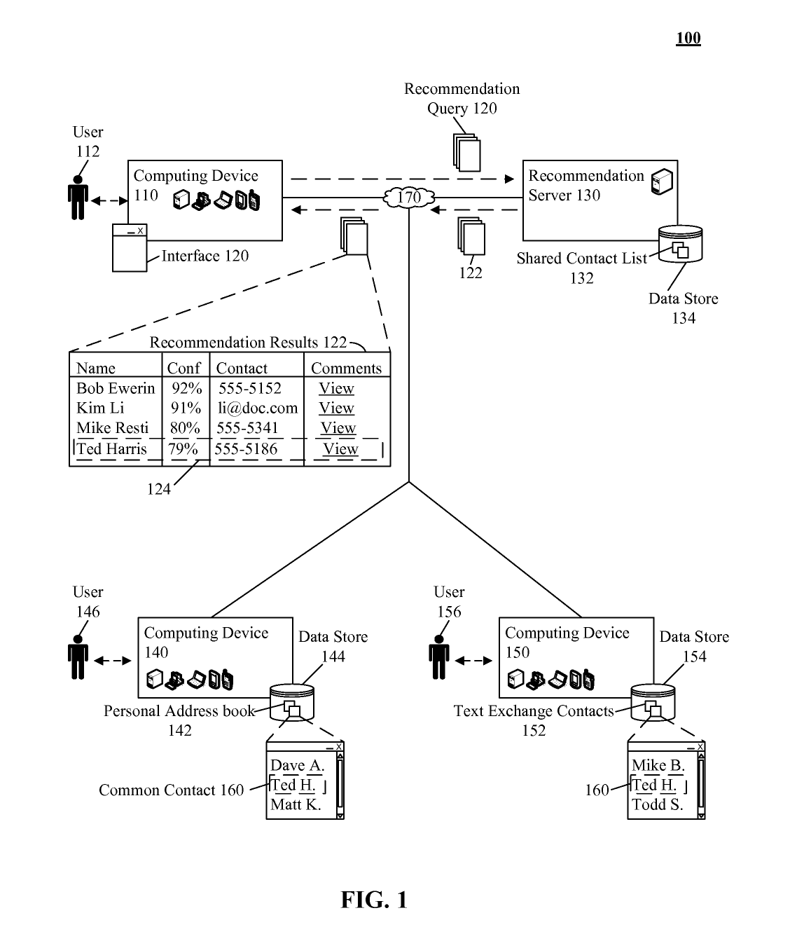

FIG. 1 is a schematic diagram illustrating a system 100 for deriving recommendations from trusted community relationships by analyzing contact lists in accordance with an embodiment of the inventive arrangements disclosed herein. In system 100, a user 112 can obtain trusted recommendations 122 from a set of private and/or public contact lists 132, 142, 152. User 112 can utilize interface 120 executing on computing device 110 to initiate a search which can provide recommendations 122 based on common contacts within lists 132, 142, 152. Lists 132, 142, 152 can be non-explicitly shared lists including, but not limited to, address book lists, text exchange contact lists, email contact lists, application/service specific contacts, and the like.

In system 100, a user 112 interacting with an interface 120 can search for a recommended product or service. Interface 120 can be a graphical user interface able to execute a user initiated search based on user established criteria. Interface 120 can be a locally executing application, a remotely executing application, a Web page, and the like. The interface 120 can be used to present results 122 and obtain additional information within results 122. Results 122 can include contact information for each recommended entry and a confidence rating indicating the degree of reliability for the recommendation. For example, confidence rating in entry 124 can indicate contact Ted Harris (present as contact 160 from multiple lists 142, 152) is the least recommended one of a set of recommended therapists.

When a user 112 initiates a search for a product and/or service recommendation, query 120 can be communicated over network 170 to recommendation server 130. Server 130 can utilize a shared contact list 132 within data store 134 to determine recommendations based on user search criteria. User established criteria can include, but is not limited to, first/last names, occupations, locations, contact list owner details, and the like. For instance, user 112 can search for a recommended local plumber that works on weekends.

Server 130 can determine the existence of search criteria in list 132 which can be added to the results 122. Search criteria in query 120 can be matched against appropriate elements of a contact in a contact list such name fields, occupation information, company names, email addresses, user defined fields, additional contact information details, and the like. For each entry in recommendation result 122, contact lists can be queried to obtain a minimum set of contact information. For example, server 130 can query contact list 152 to determine email address and telephone information for a recommended contact obtained in list 142. When contact information cannot be determined, server 130 can utilize other sources such as Web sites, social networks, and the like. In one embodiment, server 130 can interface with social networks, opt-in networks, and the like. Server 130 can utilize existing social network structures and contacts to obtain recommendations and information necessary for results 122.

In one embodiment, shared contact list 132 can be an automatically generated list comprised of personal address book 142, text exchange contacts 152, and the like. When a contact 160 appears multiple times in a shared contact list 132, the contact can be appended to recommendation results 122 with a high confidence rating. For example, a common contact between address book 142 and contacts 152 can be determined based on an analysis of the contacts in each list. Common contact 160 can be identified and included in results 122 as result entry 124. In one embodiment, the programmatic discovery of common contact 160 can be performed by an algorithm able to identify implicit relationships within a set of users 146, 156.

Recommendation results 122 can present user 112 with pertinent information for making decisions based on a queried product and/or service. Recommendation result 122 can be user configured which can include, but is not limited to, name information, confidence rating, contact information, degrees of separation, user comments, a Unified Resource Identifier (URI), and the like. For instance, result 124 can present user 112 with contact information and user commentary obtained from contact lists regarding a doctor “Ted Harris”. Further, results 122 can include interactive elements such as hyperlinks enabling content (e.g., user comments) to be linked into results 122. Results 122 can include other user interactive elements permitting user interaction. For example, entry 124 can allow user 112 to initiate a telephone call by clicking on the phone number in entry 124.

Confidence rating in results 122 can denote the reliability of the recommendation based on one or more conditions. Confidence rating for each entry in result 122 can be affected by one or more factors including, but not limited to, frequency of occurrence within contact lists, degrees of separation between lists where each occurrence was found, list owner qualifications, list owner attributes, and the like. For example, a recommendation can be rated higher if the contact appears in list 142 than if it appears in the contact list of a contact of list 142. Based on user search criteria, confidence rating can be affected by contact list owner details. For instance, a wedding planner recommended by a contact list owner who is married can be given a higher confidence rating than of a contact list owner who is unmarried.

In one embodiment, list 142, 152 can be exposed through a subscription service, whereby device 140, 150 are subscribed to the service permitting server 130 to query list contents. For example, server 130 can query data store 144, 154 for information regarding private lists on computing device 140, 150. Alternatively, list 142, 152 can be published to a service available to server 130. To address potential network 170 problems (e.g., partial network outage), list 132 can be a locally cached version of lists 142, 152 which can aid in reducing the search time and network overhead. That is, list 142 information can be searched using list 132 in the event list 142 is unable to be queried on device 140. In this scenario, device 140, 150 can be configured to propagate changes to server 130 which can update list 132 in response to changes.

In system 100, server 130 can be an optional component. In one embodiment, recommendations can be obtained in a peer-to-peer configuration where functionality encapsulated in server 130 can be present in device 110, 140, 150. In a peer-to-peer configuration device 110 can be configured to exchange contact information with device 140, 150. Based on exchanged contact information, device 110 can identify and present recommendation results 122.

In one embodiment, one or more safeguards can be utilized to protect a privacy and/or anonymity of users 146, 156 and their lists 142, 152. For example, server 130 can optionally sanitize data so that a user 112 receiving results 122 is unable to determine which users 146, 156 and contact lists 144, 154 the results 122 are based upon. In another embodiment, the results 122 can explicitly include a set of users 146, 156 and their contact information along with a recommendation 122 so that a user 112 has a point of contact to query concerning a recommendation. Users 112, 146, 156 can be permitted to establish using configuration options whether their identity is to be protected from or published to others.

In one embodiment, access to the address books 142, 152 can require a password or passcode, which the server 130 can maintain assuming user 146, 156 approval. Further, software agents can be installed on computing devices 140, 150 to extract and group information from one or more localized lists, where the grouped list is made accessible to the recommendation server. The software agents can utilize APIs or plug-ins to communicate with one or more contact management applications, within which contact lists are maintained.

Drawings presented herein are for illustrative purposes only and should not be construed to limit the invention in any regard. In one embodiment, server 130 functionality can be embodied within a Web service, a pay-per-search service, and the like. Although interface 120 is presented as a GUI, results 122 can be presented within any compatible interface including, but not limited to, a Voice User Interface (VUI), a multi-modal, and the like.

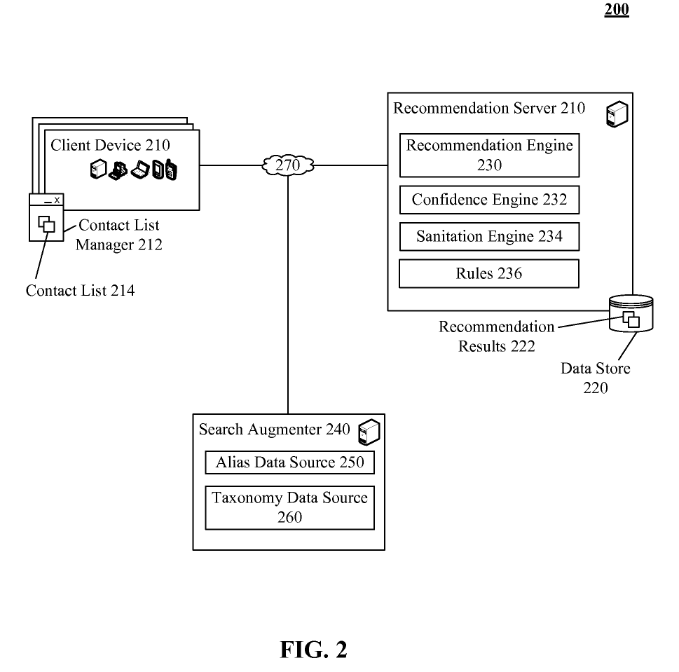

FIG. 2 is a schematic diagram illustrating a system 200 for obtaining product and/or service recommendations using common contacts discovered in contact lists in accordance with an embodiment of the inventive arrangements disclosed herein. System 200 illustrates a client-server relationship for deriving product/service recommendations using one or more private contact lists 214. Client 210 can be one of a multitude of devices on a network 270 able to share contact list 214 information. Recommendation server 210 can utilize component 230 and search augmenter 240 to provide trusted recommendations 222 for client devices 210. A search initiated on client 210 can be conveyed to server 210, which can generate results 222 using components 230-236. Results 222 can be improved when server 210 utilizes augmenter 240 to at search time. In one embodiment, a search performed by server 210 can be later refined in response to user interaction using augmenter 240. For instance, a user can invoke a refine search functionality which can modify search results 222 based on data provided by augmenter 240 to server 210.

Recommendation server 210 can be used to derive implicit recommendations from a contact list 214 for a product or service. Server 210 can comprise of recommendation engine 230, confidence engine 232, sanitation engine 234, and rules 236. Server 210 can be a middleware software, stand-alone server, network element, and the like. In one embodiment, server 210 can provide a pay-per-search service for each set of search results 222 received. In the embodiment, engine 230 can track the searches performed by subscribers (e.g., devices 210) and correlate results 222 with a payment billing. Alternatively, server 210 can permit a fee-based subscription service with periodic fees, enabling users to obtain recommended products and/or services.

Recommendation engine 230 can perform searching functionality identifying common contacts within contact lists 214 which can comprise results 222. Engine 230 can index contact lists 214 information and optionally cache the highest rated contacts to improve search time performance. Engine 230 indexing can be controlled through rules 236 which can be optionally used to limit the number of degrees of separation for which search results 222 are valid. For instance, engine can utilize first, second and third order contacts when searching for recommendations for results 222. Further, engine 230 can be used to resolve differences in contact information obtained from lists 214. Resolution can be performed by preferring the most current contact information (e.g., last updated), contact information with highest frequency, and the like. Engine 230 can track historic searches and determine which entries were most utilized to improve subsequent results 222.

Confidence engine 232 can provide a rating value associated with a result 222 for indicating the degree of reliability of a search entry. Engine 232 can be used to evaluate the rating of a search entry based on one or more conditions and rules 236. Confidence engine 232 can evaluate contact appearance frequency, list owner details, degrees of separation, and the like to calculate an appropriate confidence rating. Optionally engine 232 can utilize rating information from external sources such as rating Web sites to validate result 222 confidence rating.

Sanitation engine 234 can be used to anonymize and sanitize contact list information used in recommendation results 222. For instance, contact list owner name information can be removed during result 222 processing to protect contact list providers. Further, filters (e.g., Bayesian filter) can be applied by engine 234 to contact list 214 information to filter out potentially sensitive information. In one instance, filters can be applied to results 222 to sanitize user commentary obtained from contact lists.

Rules 236 can be utilized to control the manner in which results 222 are derived. Rules 236 can direct the depth of a search by limiting the number of degrees of separation, establish additional lists which can be searched, setting minimum rating requirements for search results 222, and the like. Rules 236 can be administratively determined rules for interacting with contact lists 214, augmenter 240, and the like. For instance, rules 236 can establish how frequently contact list 214 information can be polled.

Contact list manager 212 can be used to build a unique contact list 214 for device 210. Manager 212 can be utilized to permit or deny access to contact list information based on user configuration. For example, manger 212 can be used to deny access to a telephone contact list but permit access to a text exchange contact list. Further, manager 212 can be configured to communicate with devices containing contact list information. In one embodiment, device 210 can communicate with local and/or remote devices to obtain contact list information. For instance, manager 212 can enable device 210 to search a local mobile phone address book over a BLUETOOTH network.

Contact list 214 can be an aggregated master contact list which can be queried during user initiated searches. When changes are made to subordinate lists, master list 214 can be updated accordingly. Alternatively, list 214 can include multiple lists stored separately in the same location. List 214 information can utilize push/pull technology to allow server 210 access to list 214 information during searches. Although presented on client device 210, list 214 can be stored in data store 220 or in any remotely accessible data store.

In one configuration, results 222 can be cached in data store 220 to provide high availability and reduce search overhead. Results 222 can be stored in portions allowing reuse of specific search results, which can improve search times. Further, results 222 can be stored and can be accessible through a user history functionality, enabling users to retrieve previous searches.

Search augmenter 240 can improve search results by expanding or restricting search terms and user established criteria. Augmenter 240 can utilize data source 250, 260 to obtain criteria similar to the user search criteria which can yield better search results. Augmenter 240 is not limited to sources 250, 260, but can interface with a myriad of data sources such as search engine indexes, email systems, product/warranty registration information, and the like.

Alias data source 250 can be used to determine search parameters similar to user established criteria which can provide improved results. Source 250 can be a data source comprising of predetermined aliases for search terms which can be used to enhance search results. For instance, source 250 can be used to determine “physician” as a synonym search term for the user entered term “doctor”. Alias data source 250 can include, but is not limited to, an alias database, a thesaurus database, a dictionary database, and the like.

Taxonomy data source 260 can be utilized improve the scope of the recommendation search by supplying classification terms which can expand or restrict the search. Source 260 can be a data source comprising of taxonomy information for products, companies, occupations, and the like. For example, using source 260, a user search term “desk” can be expanded to include tables. Data source 260 can include, but is not limited to, hierarchical databases, information directories, and the like.

Although illustrated as separate entities augmenter 240, and sources 250, 260 can be combined together preserving functionality presented. In one embodiment, augmenter 240 can be a network element component, a component present in server 210, a Web service, and the like. Further, components presented in system 200 are not limited to configurations presented and can be present within a distributed computing, a networked computing environment, a cloud computing environment, and the like.

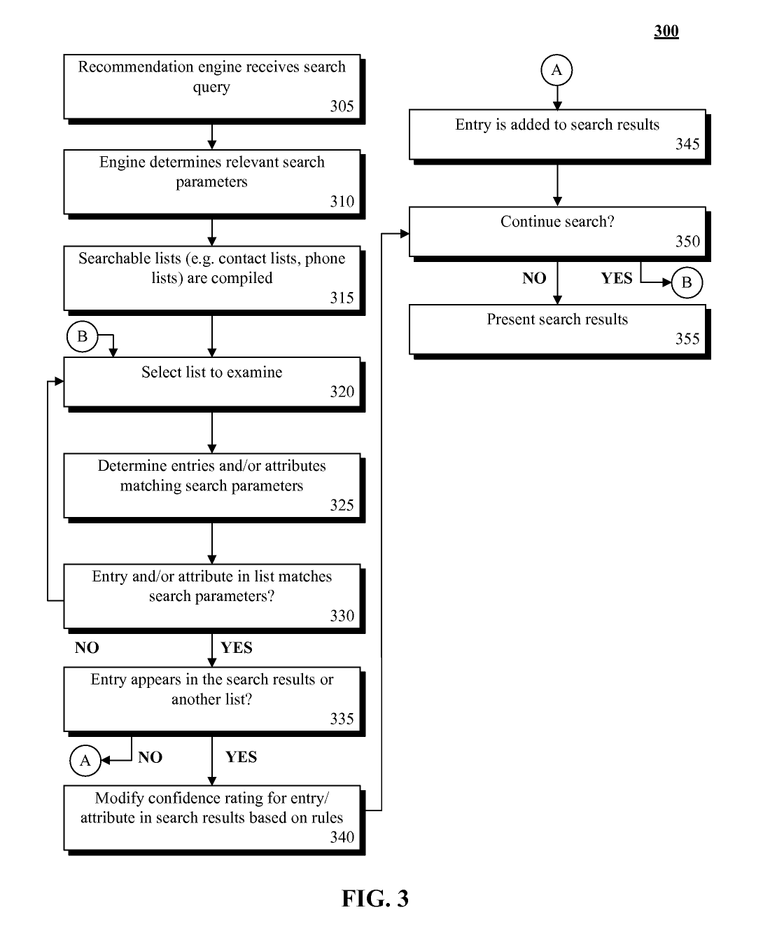

FIG. 3 is a flowchart illustrating a method 300 for providing trusted recommendations utilizing contact lists in accordance with an embodiment of the inventive arrangements disclosed herein. Method 300 can be performed in the context of system 200. In method 300, a recommendation engine can provide reliable recommendations for a user searching for a product and/or service using private and/or public contact lists. The engine can utilize common contacts between a set of contact lists to determine implicit recommendations for a user initiated search. Common contacts can be collected into the result set as a recommendation result set.

In step 305, a recommendation engine receives a search query from a user initiated search. The search query can include user specific search criteria such as a product name for determining a set of recommendations. In step 310, the engine determines the relevant search parameters based on user criteria. Parameters can include degrees of separation to limit the search to, attributes to search for, rating requirement for a recommendation, and the like. In step 315, searchable lists can be compiled into a unique list, which can be a list of lists. The lists can include contact lists, phone lists, text exchange lists, and the like. The unique lists can include contacts aggregated from applications such as email applications, VOIP applications, and the like. In step 320, the list can be selected to be examined for common contacts. In step 325, the engine determines entries and/or attributes matching search parameters. For instance, a search attribute can include a geographic location to limit recommendations to electricians local to the user.

In step 330, if the entry and/or attribute in the list matches the search parameters the method can continue to step 335, else return to step 320. In step 335, if the entry appears in the search results or in another list owned by a contact the method can proceed to step 340, else proceed to step 345. In step 340, the confidence rating for the entry/attribute appearing in the search results can be modified based on a set of rules. The rules can include a user established ruleset, user selected search parameters, administratively determined rules, and the like. In step 345, the entry matching the search parameters is added to the search results. In step 350, if the search is not completed, the method can return to step 320. The method can continue to cycle through steps 320-350 until user established criteria, rules, and/or a terminating condition is met. In step 355, the results of the search can be presented to the user. Optionally results can be presented to the user in real-time as the recommendations are determined.

The flowchart and block diagrams in the FIGS. 1-3 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for providing trusted recommendations comprising:
receiving at least one of a plurality of user established search criteria for a desired good or service;
searching a plurality of contact lists for included entries of entities which provide the desired good or service and that satisfy the user established criteria, wherein each searched contact list is a contact list of another user linked through at least one common contact to a contact list of a user from whom the user established criteria is received; and
generating a result set of entities satisfying the user established criteria from the searching.

2. The method of claim 1, wherein the search is modified to search for at least one alias of the user established search criteria, wherein the alias is a synonym term and a taxonomy.

3. The method of claim 1, wherein the user established search criteria is the limiting of the number of degrees of separation for the search to span, wherein each degree of separation corresponds to a contact list linked through another contact list by a common contact.

4. The method of claim 1, wherein the contact lists are private lists.

5. The method of claim 1, wherein the contact lists are exposed via at least one of a subscribable interface and a publishable mechanism.

6. The method of claim 1, wherein the contact list is a user established contact list.

7. The method of claim 1, wherein the contact list is an automatically generated contact list.

8. The method of claim 1, wherein the generating step includes a degree of separation calculation for at least one entity in the result set.

9. The method of claim 1, wherein each entry in the result set is associated with a confidence rating, wherein the confidence rating indicates the degree of reliability.

10. The method of claim 1, wherein the result set is sanitized, wherein the sanitization is the removal of personally identifiable information.

11. A system for providing trusted recommendations comprising:
a search query associated with at least one user established search criteria;
a contact list manager capable of handling a plurality of contact lists, wherein each contact list is associated with another contact list through a common entity;
a recommendation engine configured to determine at least one result set from the user established search criteria; and
a search augmenter able to establish at least one alias for a user established criteria for which the recommendation engine can improve the result set.

12. The system of claim 11, wherein a user established criteria is matched against at least one attribute found in the contact lists.

13. The system of claim 11, wherein the contact manager is able to build a unique contact list, wherein the contact list is comprised of contact information gathered from at least one of a plurality of contact lists associated with the owner of the contact list.

14. The system of claim 11, wherein the recommendation engine is a Web service.

15. A computer program product for trusted recommendations comprising a computer usable medium having computer usable program code embodied therewith, the computer usable program code comprising:
computer usable program code configured to receive at least one of a plurality of user established search criteria for a desired good or service;
computer usable program code configured to search a plurality of contact lists for included entries of entities which provide the desired good or service and that satisfy the user established criteria, wherein each searched contact list is a contact list of another user linked through at least one common contact to a contact list of a user from whom the user established criteria is received; and
computer usable program code configured to generate a result set of entities satisfying the user established criteria from the searching.

16. The computer program product of claim 15, wherein the search is modified to search for at least one alias of the user established search criteria, wherein the alias is a synonym term and a taxonomy.

17. The computer program product of claim 15, wherein the user established search criteria is the limiting of the number of degrees of separation for the search to span, wherein each degree of separation corresponds to a contact list linked through another contact list by a common contact.

18. The computer program product of claim 15, wherein the contact lists are private lists.

19. The computer program product of claim 15, wherein the contact lists are exposed via at least one of a subscribable interface and a publishable mechanism.

20. The computer program product of claim 15, wherein the contact list is an automatically generated contact list.
